(19) United States
(12) Patent Application Publication
(10) Pub. No.: US 2023/0253143 A1
(43) Pub. Date: Aug. 10, 2023

(54) COIL DEVICE

(71) Applicant: TDK CORPORATION, Tokyo (JP)

(72) Inventors: Kiyofumi FUJIWARA, Tokyo (JP); Michinori SUTO, Tokyo (JP); Shinichi SATO, Tokyo (JP)

(73) Assignee: TDK CORPORATION, Tokyo (JP)

(21) Appl. No.: 18/164,873

(22) Filed: Feb. 6, 2023

(30) Foreign Application Priority Data
Feb. 9, 2022 (JP) 2022-018913

(51) Int. Cl. H01F 27/29; H01F 27/24

(52) U.S. Cl. CPC H01F 27/292; H01F 27/24

(57) ABSTRACT

A coil device 10 including a core having a core center part 23 for disposing roughly perpendicularly to a mounting surface and a flange 22 formed to one end in an axial direction of the core center part 23;

a coil 30 disposed around the core center part 23; and

an electrode 40 connected to a lead part 30a of the coil 30 and formed at least partially to a circumference surface of the flange 22; wherein

the electrode 40 on the circumference surface of the flange 22 has a recessed part 420 which is recessed from an edge of the electrode 40 towards an outer end surface 221 of the flange 22.

### TECHNICAL FIELD

The present disclosure relates to a coil device.

### BACKGROUND

Conventionally, a coil device which is provided with a drum core, and such drum core is a so-called vertical type drum core in which a core center part is roughly perpendicular to a mounting face. In this type of the coil device, for example as shown in Patent Document 1, an electrode is formed so that it extends over an outer end surface and a circumference surface of the flange. Here, part of the electrode formed to the outer end surface of the flange functions as the mounting surface for a mounting substrate, and part of the electrode formed to the circumference surface functions as a surface for forming a solder fillet. When the coil device is mounted on the mounting substrate, by forming the solder fillet to part of the electrode formed to the circumference surface of the flange, the coil device can be mounted with sufficient mounting strength on the mounting substrate.

However, regarding the invention disclosed in the Patent Document 1, when a circumference surface of the coil is arranged close to part of the electrode formed to the circumference surface of the flange, the electrode may contact the circumference surface of the coil, hence there is a risk of causing short circuit between these two. Also, when the solder fillet is formed to part of the electrode formed to the circumference surface of the flange, part of the solder fillet may be on (overflow towards) the inner end surface of the flange, and the solder fillet may contact the circumference of the coil; and this may cause a short circuit. Hence, a technology of overcoming such problem has been in demand.

[Patent Document 1] JP Patent Application Laid Open No. 2006-269644

### SUMMARY

The present disclosure has been achieved in view of such circumstances, and the object is to provide a coil device capable of preventing a short circuit between an electrode and a coil, and also preventing a short circuit between the coil and a conductive member adhered to the electrode.

In order to achieve the above object, the coil device according to the present disclosure includes

a core having a core center part for disposing roughly perpendicularly to a mounting surface and a flange formed to one end in an axial direction of the core center part;

a coil disposed around the core center part; and

an electrode connected to a lead part of the coil;

wherein

the electrode on a circumference surface of the flange has a recessed part which is recessed from an edge of the electrode towards an outer end surface of the flange.

In the coil device according to the present disclosure, the electrode has the recessed part which is recessed towards the outer end surface of the flange. Hence, at the position corresponding to the recessed part, the electrode is formed at the position which is spaced away from the circumference surface of the coil by the distance corresponding to a depth of the recessed part. Thereby, a risk that the circumference surface of the coil and the electrode contacting each other can be reduced, and the short circuit between the coil and the electrode can be prevented.

Also, at the position corresponding to the recessed part, the electrode is formed at the position by taking a distance from the inner end surface of the flange for the distance corresponding to a depth of the recessed part. Therefore, when a conductive member (such as a solder fillet) adheres to the electrode, it makes the solder fillet difficult to be on (overflow towards) the inner end surface of the flange. Thereby, a risk that the circumference surface and the electrode contacting each other can be reduced, and the short circuit between the coil and the electrode can be prevented.

Further, by forming an electrode material to the circumference surface of the flange so that the recessed part is formed when the electrode is formed to the circumference of the flange, the electrode material unintentionally being on the inner end surface can be prevented.

Preferably, the circumference surface of the flange includes an electrode non-formed area corresponding to the recessed part, wherein

the flange has an intersection located between an inner end surface and the circumference surface;

the electrode non-formed area is provided between the electrode and the intersection; and

the electrode non-formed area does not have the electrode.

When the electronic device is configured as such, at the position corresponding to the recessed part, the electrode non-forming area is formed between the circumference surface of the coil and the electrode, hence, the electrode and the circumference surface of the coil can be separated by the distance roughly equivalent of the electrode non-forming area. Thus, a risk of the circumference surface of the coil contacting the electrode can be effectively prevented.

Also, since the electrode non-forming area is formed between the inner end surface of the flange and the electrode at the position corresponding to the recessed part is formed, the electrode and the inner end surface of the flange can be separated by the distance roughly equivalent of the electrode non-forming area. Therefore, it is difficult that the solder fillet formed on the electrode to partially be on the inner end surface of the flange, hence, a risk of the circumference surface of the coil contacting the solder fillet can be effectively prevented.

Preferably, the electrode extends along a circumference direction of the flange, and

the recessed part is formed at a center area in an extending direction of the electrode.

By taking such configuration, the recessed part can be formed in a wide area taking the center part of the electrode in the extending direction as a center and can extend along the extending direction of the electrode. Therefore, a risk of the circumference surface of the coil contacting the electrode or the solder fillet can be effectively prevented.

Also, usually, the electrode and the circumference surface are closest at the center part of the electrode in the extending direction. Thus, by forming the recessed part at the center part of the electrode in the extending direction, a risk of the circumference surface of the coil contacting the electrode or the solder fillet can be effectively reduced.

Preferably, the electrode extends along a circumference direction of the flange, and

a thickness of the electrode on the circumference surface becomes thinner toward a center area in an extending direction of the electrode.

By making the thickness of the electrode thinner, the electrode less projects out from the circumference surface of the flange, and a risk of the circumference surface of the coil contacting the electrode or the solder fillet can be reduced. Particularly, by making the thickness of the electrode thinner towards the center part of the electrode along the extending direction, the area with thin electrode thickness can be formed in a wide range along the extending direction of the electrode taking the center part of the electrode in the extending direction as a center. Thereby, a risk of the circumference surface of the coil contacting the electrode or the solder fillet can be reduced.

Preferably, a thickness of the electrode on the circumference surface becomes thinner toward an inner end surface of the flange. By configuring as such, the closer it is to the inner end surface side of the flange, that is the closer to the coil, the lesser the electrode projects out from the circumference surface of the flange, and a risk of the circumference surface of the coil contacting the electrode or the solder fillet can be reduced. Also, the closer the position is to the coil, the lesser the solder fillet formed on the electrode projects out; and a risk of the circumference surface of the coil contacting the solder fillet can be reduced. In addition, part of the solder fillet formed on the electrode is less likely to be on the inner end surface of the flange, hence also from this point, a risk of the circumference surface of the coil contacting the solder fillet can be effectively reduced.

Preferably, the electrode includes a wire connecting part connected to a lead part of the coil, and

the wire connecting part is provided at a different position from a position of the recessed part.

At such position, an electrode width of the wire connecting part can be secured sufficiently along the axis direction of the core center part compared to the position corresponding to the recessed part. Thus, by providing the wire connecting part to the different position from the position corresponding to the recessed part, the lead part of the coil can be securely connected to the wire connecting part.

Preferably, the flange has a polygonal shape when viewed from the axial direction of the core center part,

the circumference surface of the flange has a plurality of surfaces along a circumference direction of the flange,

the electrode is formed in a continuous manner to at least two surfaces among the plurality of surfaces of the circumference surface of the flange, and

the wire connecting part is formed on one of the surfaces different from another one of the surfaces that the recessed part is formed.

By configuring as such, at the surface where the wire connecting part is formed, the sufficient electrode width of the wire connecting part can be secured along the axial direction of the core center part, and the lead part of the coil can be securely connected to the wire connecting part. Also, at the surface where the recessed part is formed, a sufficient distance can be secured between the circumference face of the coil and the electrode, and a risk of the circumference surface of the coil contacting the electrode can be effectively reduced. Also, a sufficient distance can be secured between the inner end surface of the flange and the electrode, and thus, the solder fillet formed on the electrode can be effectively prevented from partially being on the inner end surface of the flange.

Preferably, the electrode on the circumference surface has a thinner thickness at the position of the recessed part compared to the position of the wire connecting part. By configuring as such, the thickness of the electrode becomes thinner in relativity at the position of the recessed part, and the thickness of the electrode is thicker in relativity at the position of the wire connecting part. Thus, due to the various effects mentioned in above, such as a reduced risk of the circumference surface of the coil contacting the electrode, a reduced risk of the circumference surface of the coil contacting the solder fillet (preventing the solder fillet from being on the inner end surface of the flange), and an enhanced connection reliability of the lead part of the coil to the wire connecting part can be achieved.

Preferably, the electrode includes a metal and glass By taking such configuration, the electrode can be formed to the circumference surface of the flange with a sufficient strength.

### BRIEF DESCRIPTION OF THE SEVERAL VIEWS OF THE DRAWING(S)

FIG. 1 is a perspective view of a coil device according to one embodiment of the present disclosure.

FIG. 2 is a perspective view of the coil device of FIG. 1 without showing an exterior resin.

FIG. 3A is a side view of the coil device shown in FIG. 1 looking from the direction of IIIA.

FIG. 3B is a side view of the coil device shown in FIG. 1 looking from the direction of IIIB.

FIG. 4 is a bottom view of the coil device shown in FIG. 1.

FIG. 5A is a cross section view of the coil device shown in FIG. 1 along VA-VA line.

FIG. 5B is a cross section view of the coil device shown in FIG. 1 along VB-VB line.

FIG. 6A is a partially enlarged cross section view of the coil device shown in FIG. 3A along VIA-VIA line.

FIG. 6B is a partially enlarged cross section view of the coil device shown in FIG. 3A along VIB-VIB line.

### DETAILED DESCRIPTION

In below, the present disclosure is described in detail based on embodiments shown in figures.

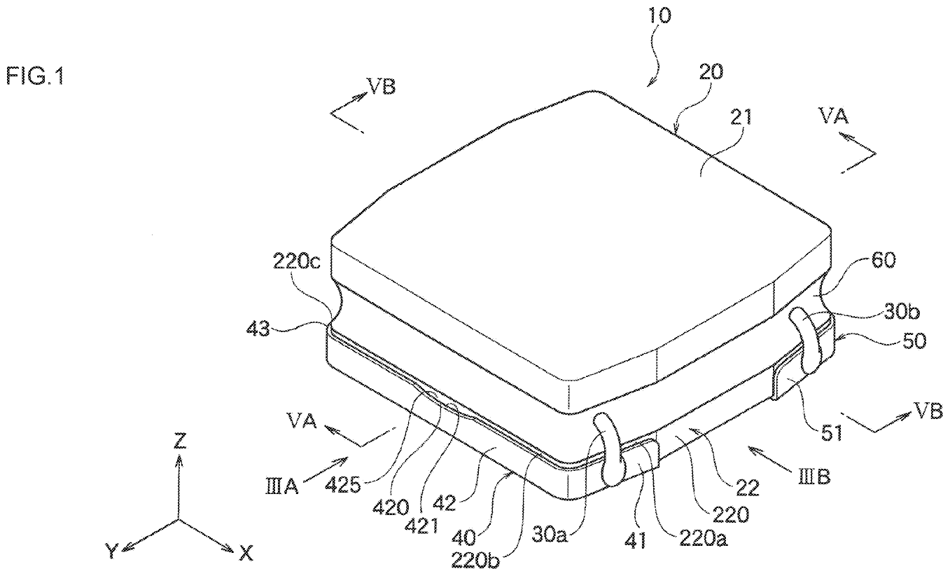

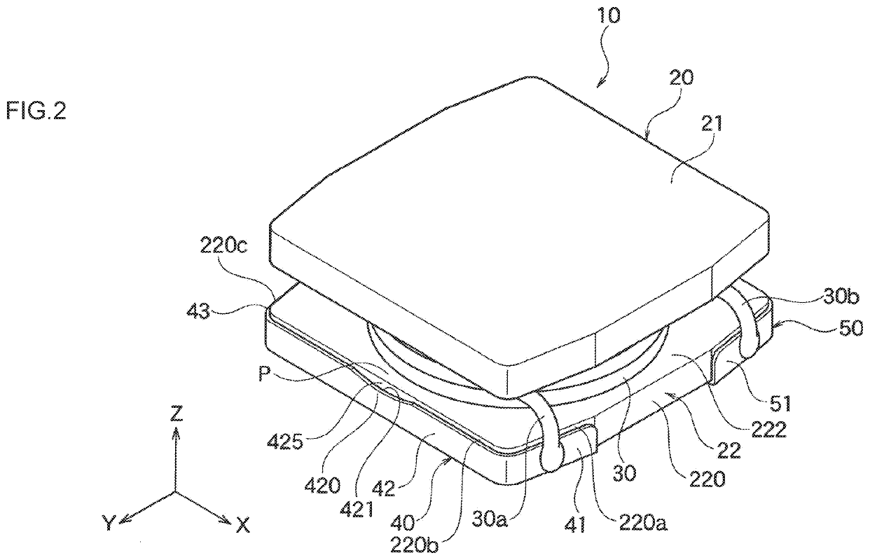

As shown in FIG. 1, a coil device 10 according to one embodiment of the present disclosure is used as a device for automobile; and for example, it functions as an inductor. The coil device 10 has a core 20, a coil 30 (FIG. 2), a first electrode 40, and a second electrode 50. Also, in addition to these, the coil device 10 may have an exterior resin 60.

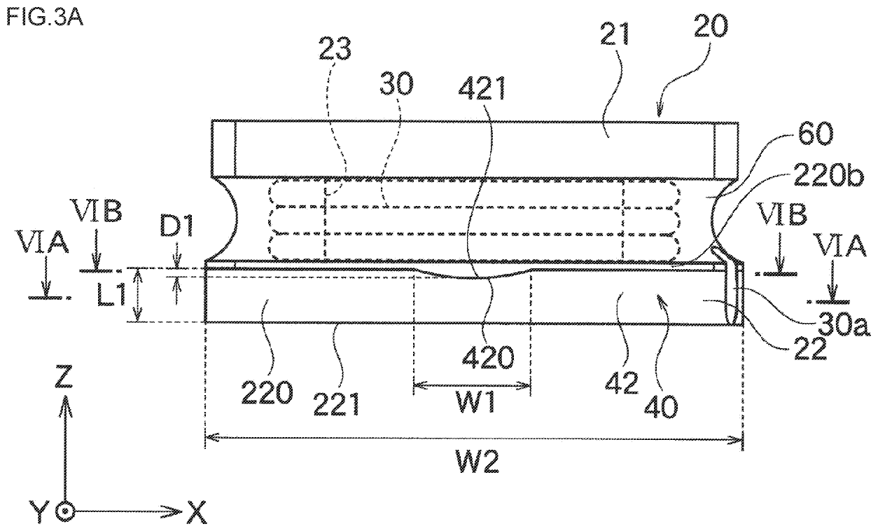

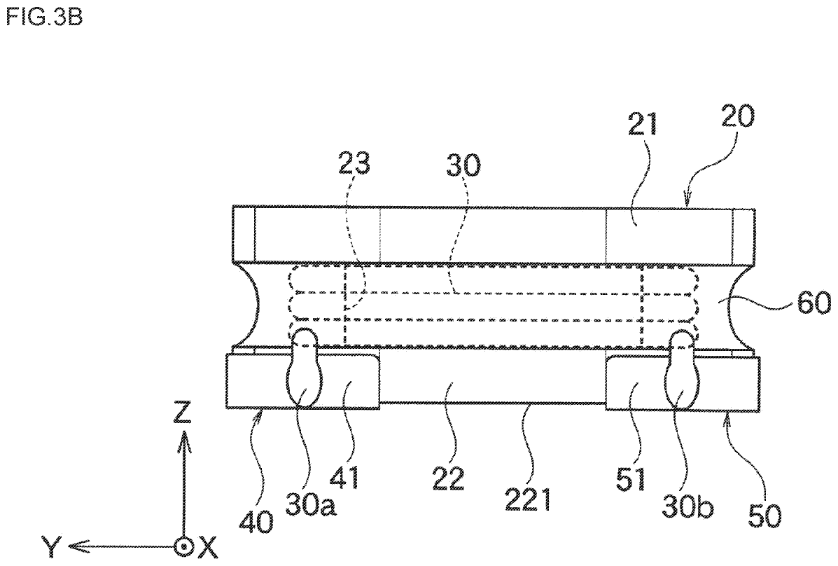

In FIG. 1, X-axis matches an extending direction of a long side of each of the first electrode 40 and second electrode 50. Y-axis matches the direction that the first electrode 40 and the second electrode 50 facing to each other. Z-axis is an axis extending perpendicularly to the mounting surface of the coil device 10, and it matches with the axial direction of the core center part 23 (FIG. 3A) of the core 20.

As shown in FIG. 2, the core 20 has a first flange 21, a second flange 22, and the core center part 23 (FIG. 3A). In the core 20, the core center part 23 is arranged roughly perpendicularly to the mounting surface, which is a so-called a vertical type drum core. The size of the core 20 is not particularly limited, and a width in X-axis direction is within a range of 1.0 to 6.0 mm, a width in Y-axis direction is with in a range of 1.0 to 6.0 mm, and a width in Z-axis direction is within a range of 0.5 to 3.0 mm.

The core 20 is formed of a material including a magnetic material and a resin. As the magnetic material forming the core 20, ferrite particles, magnetic metal particles, and so on are mentioned as examples. As the ferrite particles, Ni—Zn-based ferrite, Mn—Zn-based ferrite, and so on are mentioned as examples. The magnetic metal particles are not particularly limited, and Fe—Ni alloy powder, Fe—Si alloy powder, Fe—Si—Cr alloy powder, Fe—Co alloy powder, Fe—Si—Al alloy powder, amorphous iron, and so on are mentioned as examples. The resin forming the core 20 is not particularly limited, and an epoxy resin, a phenol resin, a polyester resin, a polyurethane resin, a polyimide resin, other synthetic resins, other non-magnetic materials, and so on are mentioned as examples. Note that, the core 20 may be a sintered magnetic metal material.

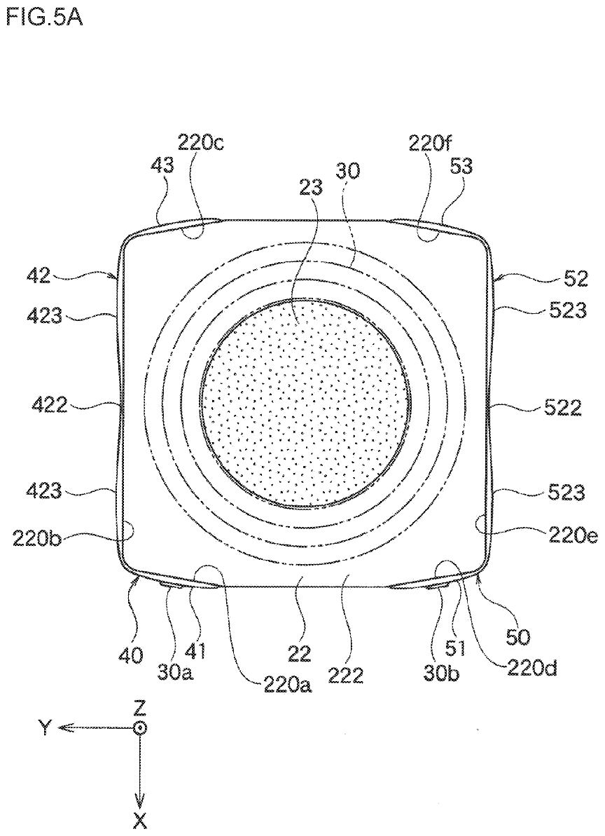

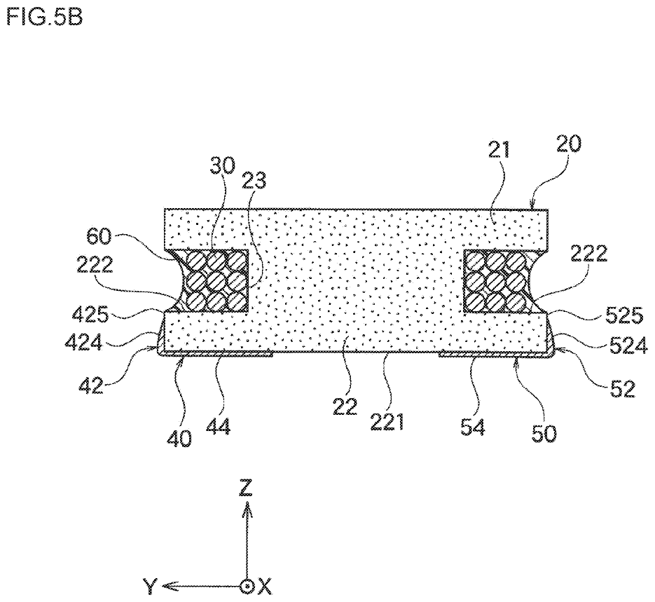

The core center part 23 (see FIG. 3A and FIG. 5A) has a columnar shape, and a horizontal cross section has roughly a circular shape. The shape of the horizontal cross section of the core center part 23 is not particularly limited, and it may be a rectangular shape, an approximately octagonal shape, or any other polygonal shapes. The core center part 23 is arranged roughly perpendicular to the mounting surface. The coil 30 is installed to the circumference surface of the core center part 23. A circumference surface of the coil 30 is arranged near an outer edge of the second flange 22. Note that, as the wire which forms the coil 30, for example, those made by covering a core material made of a conductor such as copper or so with an insulation material such as imide-modified polyurethane, and further covering the outermost surface with a thin resin layer such as polyester and the like can be used.

The first flange 21 is formed to one end (upper end) in the axial direction of the core center part 23, and the second flange 22 is formed to the other end (lower end) in the axial direction of the core center part 23. The thickness of each of the first flange 21 and the second flange 22 is not particularly limited, and the thickness of each of these is within a range of 300 to 600 μm. The first flange 21 and the second flange 22 have the same shapes, and when viewed from Z-axis direction, it is approximately an octagonal shape. Note that, the shapes of the first flange 21 and the second flange 22 viewed from Z-axis direction are not limited to these, and it may be a circular shape, an oval shape, a square shape (rectangular parallelepiped shape), a hexagonal shape, and any other polygonal shapes when viewed from Z-axis direction.

When the coil device 10 is mounted on a mounting substrate (not shown in the figure), the bottom surface of the second flange 22 is arranged so that it faces the mounting substrate. Note that, identifiers such as barcode and so on may be applied on the upper surface of the first flange 21.

The first electrode 40 and the second electrode 50 have symmetrical shapes to each other. The first electrode 40 and the second electrode 50 are made of conductive members, and for example, these are made of a metal paste fired film, a metal plating film, and so on. The lead part 30a which is one end of the coil 30 is connected to the first electrode 40, for example, by heat compression. The lead part 30b which is the other end of the coil 30 is connected to the second electrode 50, for example, by heat compression.

The first electrode 40 is formed at one end side in Y-axis direction, and also it is formed over the circumference surface (lateral side surface) of the second flange 22 and the outer end surface (mounting surface) 221. At the circumference surface 220, the first electrode 40 is formed over the three adjacent surfaces (a first surface 220a, a second surface 220b, and a third surface 220c) which are connected. At one side in Y-axis direction, the first electrode 40 extends roughly in a C-like shape (or in an arc shape) along a circumference direction of the second flange 22.

At the other end side in Y-axis direction, the second electrode 50 is formed over the circumference surface (lateral side surface) of the second flange 22 and the outer end surface 221. At the circumference surface 220, the second electrode 50 is formed over the three adjacent surfaces (a fourth surface 220d, a fifth surface 220e, and a sixth surface 220f shown in FIG. 5A) which are connected. At the other end in Y-axis direction, the second electrode 50 extends roughly in a C-like shape (or in an arc shape) along a circumference direction of the second flange 22.

The first electrode 40 and the second electrode 50 are formed, for example, by coating and baking Ag paste on the circumference surface 220 and the outer end surface 221 of the second flange 22, then forming a plating layer on the surfaces of the circumference surface 220 and the outer end surface 221 using electrolytic plating or electroless plating. The material of a metal paste is not particularly limited, and a Cu paste, an Ag paste, and so on are mentioned as examples. Also, the plating layer may be a single layer of a plurality of layers, and for example, plating layers such as a Cu plating, a Ni plating, a Sn plating, a Ni—Sn plating, a Cu—Ni—Sn plating, a Ni—Au plating, an Au plating, and so on are mentioned as examples. The thickness of the first electrode 40 and the thickness of the second electrode 50 are not particularly limited, and preferably, the thicknesses are within a range of 0.1 to 30 μm.

Note that, the first electrode 40 and the second electrode 50 may include glass in addition to the above-mentioned metals. In such case, the first electrode 40 and the second electrode 50 having sufficient connection strength can be formed to the circumference surface 220 of the second flange 22. Also, the first electrode 40 and the second electrode 50 may be formed of a conductive paste layer (a composite material including conductive particles and resin) which is made by curing a conductive paste such as an Ag paste and the like.

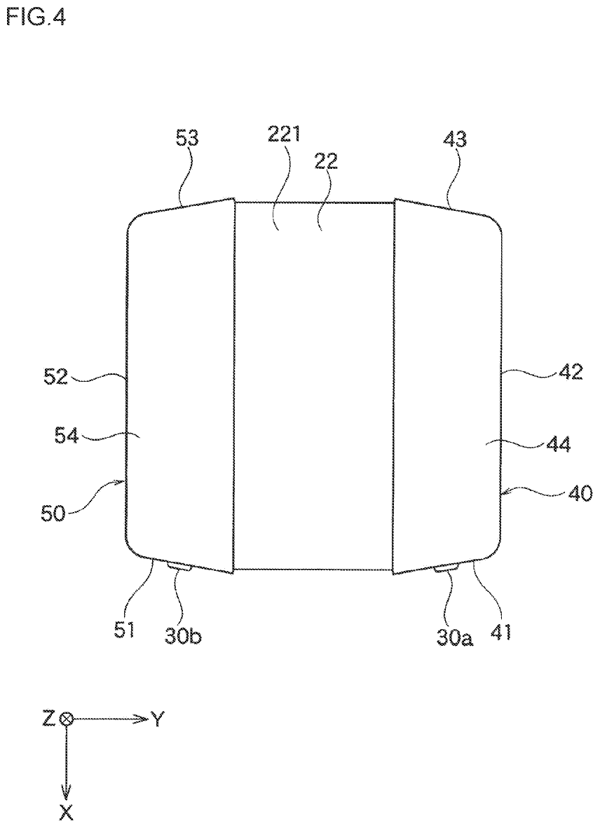

The first electrode 40 has a wire connecting part 41, a side surface electrode part 42, a supplementary electrode part 43, and a mounting part 44 (FIG. 4). The wire connecting part 41 is formed to the first surface 220a of the circumference surface 220. The lead part 30a of the coil 30 is connected to the wire connecting part 41. A small space is formed between the upper end of the wire connecting part 41 and the upper end of the first surface 220a, but the wire connecting part 41 may be formed to entire first surface 220a without having any space. A length of the wire connecting part 41 in Z-axis direction is preferably longer than a half the length of the circumference surface 220 of the second flange 22 in Z-axis direction (the thickness of the second flange 22). The same applies to the side surface electrode part 42 and the supplementary electrode part 43.

As shown in FIG. 5A, the thickness of the wire connecting part 41 gradually becomes thinner towards the intersection (corner part) between the first surface 220a of the second flange 22 and the adjacent face in a clockwise direction (the second surface 220b). That is, the wire connecting part 41 has a tapered shape such that the thickness gradually becomes thinner towards the side surface electrode part 42 along the circumference direction of the second flange 22.

Also, the thickness of the wire connecting part 41 becomes thinner towards the intersection between the first surface 220a of the second flange 22 and the adjacent surface in counter clockwise direction. That is, the wire connecting part 41 has a tapered shape such that the closer it is to one end in the extending direction of the first electrode 40 along the circumference direction of the second flange 22, the thickness gradually becomes thinner.

As shown in FIG. 2, the side surface electrode part 42 is formed to the second surface 220b which is adjacent to the first surface 220a of the second flange 22. That is, the side surface electrode part 42 is formed to the surface different from the surface where the wire connecting part 41 is formed. The side surface electrode part 42 functions as a solder fillet forming part; and for example, when the coil device 10 is solder mounted on the mounting substrate, the solder fillet is formed on the side surface electrode part 42. The solder fillet which is formed on the side surface electrode part 42 is considered as a part to be checked for an appearance check after the coil device 10 is solder mounted.

The side surface electrode part 42 is connected to the wire connecting part 41 in a continuous manner (integrally formed); and the side surface electrode part 42 forms a predetermined angle with the wire connecting part 41 (an angle formed between the first surface 220a and the second surface 220b) and extends in X-axis direction. The side surface electrode part 42 and the wire connecting part 41 are connected in a continuous manner, hence, the intersection between the first surface 220a and the second surface 220b of the second flange 22 are covered with the first electrode 40. The upper edge of the side surface electrode part 42 and the upper edge of the second surface 220b have a slight space in between, however, the side surface electrode part 42 may be formed to the entire second surface 220b without having a space in between (except for the area where the recessed part 420 is formed, which will be described in below).

The supplementary electrode part 43 is formed on the third surface 220c which is the adjacent surface to the second surface 220b of the second flange 22. That is, the supplementary electrode part 43 is formed to the surface which is different from the surface where the side surface electrode part 42 is formed. When the coil device 10 is mounted on the mounting substrate, for example by solder mounting, the solder fillet may be formed on the supplementary electrode part 43.

The supplementary electrode part 43 is positioned at the opposite side in X-axis direction of the wire connecting part 41; and the supplementary electrode part 43 and the wire connecting part 41 have the same shapes. The supplementary electrode part 43 is connected to the side surface electrode part 42 in a continuous manner (integrally formed); and the supplementary electrode part 43 forms a predetermined angle with the side surface electrode 42 (the angle formed between the second surface 220b and the third surface 220c) and extends along the third surface 220c. The supplementary electrode part 43 and the side surface electrode 42 are connected in a continuous manner, hence, the intersection between the second surface 220b and the third surface 220c of the second flange 22 are covered with the first electrode 40. Although the details are not shown in the figures, the upper edge of the supplementary electrode part 43 and the upper edge of the third surface 220c have a small space in between. However, the supplementary electrode part 43 may be formed on the third surface 220c without having any space.

As shown in FIG. 5A, the thickness of the supplementary electrode part 43 becomes thinner towards the intersection between the third surface 220c of the second flange 22 and the adjacent surface in a counter clockwise direction (the second surface 220b). That is, the supplementary electrode part 43 has a tapered shape such that the thickness gradually becomes thinner towards the side surface electrode part 42 along the circumference direction of the second flange 22.

Also, the thickness of the supplementary electrode part 43 becomes thinner towards the intersection between the third surface 220c of the second flange 22 and the adjacent surface in a counter clockwise direction. That is, the supplementary electrode part 43 has a tapered shape such that the thickness gradually becomes thinner towards the other end of the first electrode in the extending direction of the first electrode 40 along the circumference direction of the second flange 22.

As shown in FIG. 4, the mounting part 44 is formed to the outer end surface 221 of the second flange 22. The mounting part 44 has a predetermined width along Y-axis direction and extends from one end to the other end of the outer end surface 221 in X-axis direction. The mounting part 44 functions as a connecting part with the mounting substrate, and the coil device 10 can be mounted on the mounting substrate via the mounting part 44.

As shown in FIG. 4 and FIG. 5A, the second electrode 50 has a wire connecting part 51, a side surface electrode part 52, a supplementary electrode part 53, and a mounting part 54. The wire connecting part 51 is formed on a fourth surface 220d of the second flange 22; the side surface electrode part 52 is formed on a fifth surface 220e; and the supplementary electrode part 53 is formed on a sixth surface 220f. The wire connecting part 51, the side surface electrode part 52, the supplementary electrode part 53, and the mounting part 54 respectively have the same shapes and functions as the wire connecting part 44, the side surface electrode 42, the supplementary electrode part 43, and the mounting part 44. Thus, the detailed descriptions of these will be omitted.

Note that, as shown in FIG. 2, a lead part 30b of the coil 30 is connected to the wire connecting part 51. The lead part 30b is pulled out to the same side (to X-axis positive side) as the lead part 30a. Therefore, the wire connecting part 51 is arranged at the same side (to X-axis positive side) as the wire connecting part 41. Note that, the direction that the lead part 30b is pulled out may be the opposite direction in X-axis direction from the direction that the lead part 30a is pulled out. In such case, the supplementary electrode part 53 of the second electrode 50 may function as a wire connecting part.

In the present embodiment, as described in below, the side surface electrode part 42 of the first electrode 40 has a distinctive characteristic shape (the same applies to the side surface electrode part 52 of the second electrode 50). As shown in FIG. 2, the side surface electrode part 42 has the recessed part 420. The recessed part 420 is formed at the upper edge part (upper end part) of the side surface electrode part 42, and it is recessed towards the outer end surface 221 of the second flange 22 along Z-axis direction.

The recessed part 420 is formed at the center part in the extending direction (X-axis direction) of the first electrode 40 (the side surface electrode part 42). Here, the center part in X-axis direction of the first electrode 40 (the side surface electrode part 42) matches a position P where the circumference surface of the coil 30 is closest to the circumference surface 220 of the second flange 22. In other words, the position P is at a position where the distance between the circumference surface of the coil 30 and the circumference surface 220 of the second flange 22 is the smallest.

In the present embodiment, the recessed part 420 is provided to the side surface electrode part 42 to provide a distance between the side surface electrode part 42 and the circumference surface of the coil 30 at the position P. Therefore, the recessed part 420 is recessed in a direction away from the circumference surface of the coil 30. Thereby, a risk of the side surface electrode part 42 and the circumference surface of the coil 30 contacting each other can be reduced, or a risk of the solder fillet formed to the side surface electrode part 42 contacting the circumference surface of the coil 30 can be reduced.

The recessed part 420 is provided at the position (surface) different from where the wire connecting part 41 is formed. By providing the wire connecting part 41 to the position different from where the recessed part 420 is formed, a sufficient electrode width of the wire connecting part 41 can be secured in Z-axis direction, and the lead part 30a of the coil 30 can be securely connected to the wire connecting part 41.

As shown in FIG. 3A, the depth of the recessed part 420 gradually increases towards the center in X-axis direction of the side surface electrode 42. A proportion of the depth D1 of the recessed part 420 to the length L1 of the side surface electrode part 42 in Z-axis direction which is represented by D1/L1 is preferably within a range of 1/20 to ¼, or more preferably within a range of 1/20 to ⅙. As D1/L1 is within the above-mentioned range, the risk of first electrode 40 contacting the circumference surface of the coil 30, or the risk of the solder fillet formed to the side surface electrode part 42 contacting the circumference surface of the coil 30 can be reduced. Note that, a proportion of the depth D1 of the recessed part 420 to the thickness of the second flange 22 may be within the above-mentioned range as well.

A base surface 421 of the recessed part 420 is a curved surface which curves roughly in a C-like shape (arc shape). The base surface 421 is positioned to the upper side than the center of the second surface 220b of the second flange 22 in Z-axis direction. At the position of a bottom part of the recessed part 420 (the position where the depth D1 of the recessed part 420 is at the maximum), a length of the first electrode 40 in Z-axis direction (the height of the first electrode 40) is larger than a half the length of the second flange 22 in Z-axis direction.

As shown in FIG. 2, the end part of the recessed part 420 in the X-axis positive direction is at the position which is a predetermined distance away from the intersection between the first surface 220a and the second surface 220b of the second flange 22 toward the X-axis negative direction. Also, the end part of the recessed part 420 in X-axis negative direction is at the position which is a predetermined distance away from the intersection between the third surface 220c and the second surface 220b of the second flange 22 toward X-axis positive direction.

As shown in FIG. 3A, a width W1 of the recessed part 420 in X-axis direction is smaller than a width W2 of the second flange 22 in X-axis direction. Also, the width W1 of the recessed part 420 in X-axis direction is smaller than a width of the second surface 220b of the second flange 22 in X-axis direction. A proportion W1/W2 which is the width W1 of the recessed part 420 in X-axis direction to the width W2 of the second flange 22 in X-axis direction may be within a range of ⅙ to ⅓. By having W1/W2 within the above-mentioned range, a risk of the first electrode 40 and the circumference surface of the coil 30 contacting each other can be reduced, or a risk of the solder fillet formed on the side surface electrode part 42 contacting the circumference surface of the coil 30 can be reduced. Note that, the proportion of the width W1 of the recessed part 420 in X-axis direction to the width of the second surface 220b of the second flange 22 may also be within the above-mentioned range as well.

As shown in FIG. 2, at the position corresponding to the recessed part 420, an electrode non-formed area 425 which is an area where the side surface electrode part 42 is substantially not formed is provided; and the electrode non-formed area 425 is provided between the first electrode 40 (the side surface electrode part 42) and the intersection of the inner end surface 222 and the circumference surface 220 of the second flange 22. The electrode non-formed area 425 has a concave shape defined by the recessed part 420 (the base surface 421), and the electrode non-formed area 425 has a shape which is curved towards the outer end surface 221 side.

The electrode non-formed area 425 is formed to the circumference surface 220 as a result of the recessed part 420 being formed to the first electrode 40. Therefore, the length of the electrode non-formed area 425 in Z-axis direction matches the depth of the recessed part 420, and the width of the electrode non-formed area 425 in X-axis direction matches the width of the recessed part 420 in X-axis direction. Also, the lower edge of the electrode non-formed area 425 is the upper edge of the side surface electrode part 42.

As such, when the electrode non-formed area 425 is formed to the circumference surface 220, at the position corresponding to the recessed part 420, the electrode non-formed area 425 is formed between the circumference surface of the coil 30 and the side surface electrode part 42. Thus, the side surface electrode part 42 and the circumference surface of the coil 30 can be spaced apart by the distance (insulation distance) which corresponds to the size of the electrode non-formed area 425. Therefore, a risk of the circumference surface of the coil 30 contacting the side surface electrode 42 can be reduced.

Also, at the position corresponding to the recessed part 420, the electrode non-formed area 425 exists between the inner end surface 222 of the second flange 22 and the side surface electrode part 42, thus, the side surface electrode part 42 and the inner end surface 222 can be spaced apart along Z-axis direction by the distance which corresponds to the size of the electrode non-formed area 425. Therefore, part of the solder fillet formed on the side surface electrode part 42 becomes difficult to be on the inner end surface 222, and a risk of the circumference surface of the coil 30 contacting the solder fillet can be effectively can be reduced.

Note that, the side surface electrode part 42 preferably does not exist at the electrode non-formed area, however, the side surface electrode part 42 may be slightly formed (to the level that can be ignored). For example, at the electrode non-formed area 425, part of the side surface electrode part 42 may exist in an extremely thin thickness which does not influence the solder fillet forming.

As shown in FIG. 5A, the side surface electrode part 42 has a thin part 422 and a thick part 423. The thin part 422 and the thick part 423 are connected in a continuous manner (integrally formed). The thin part 422 is formed at the center part in the extending direction (X-axis direction) of the side surface electrode part 42, that is, at the position corresponding to the recessed part 420, and the thin part 422 is recessed towards the center (a winding axis of the core center part 23) of the second flange 22. The surface of the thin part 422 has roughly a C-like shape (arc shape) when viewed from Z-axis direction. In the thin part 422, the thinnest part is positioned roughly at the center of the side surface electrode part 42 in X-axis direction.

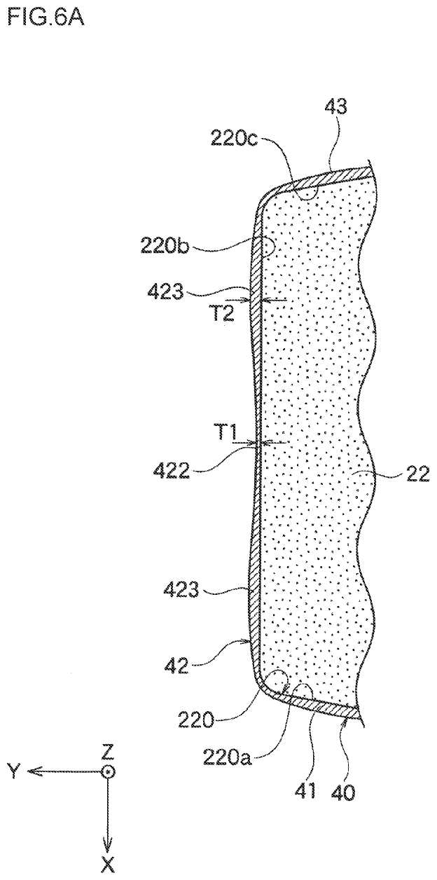

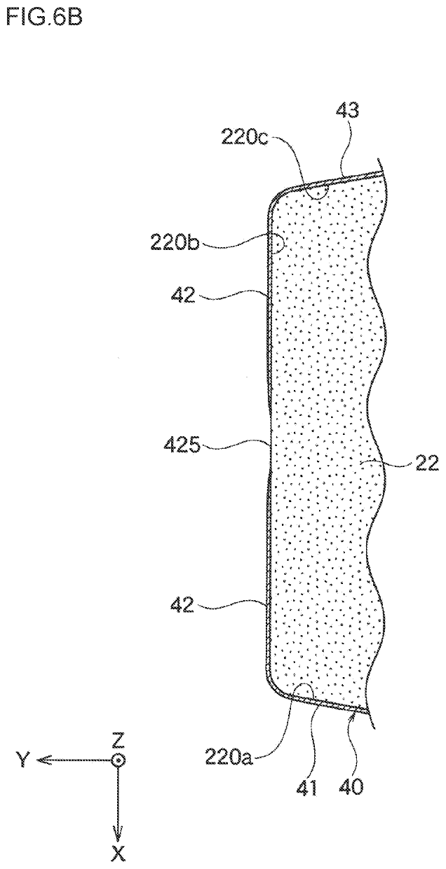

The thickness of the thin part 422 (the side surface electrode part 42) gradually becomes thinner towards the center part of the side surface electrode part 42 in the extending direction (X-axis direction). In other words, the thickness of the side surface electrode part 42 becomes thinner towards the recessed part 420. Therefore, the thin part 422 has a tapered shape such that the thickness gradually becomes thinner towards the center part of the side surface electrode part 42 in X-axis direction. As shown in FIG. 6A, a proportion of a thickness T1 of the thin part 422 to a thickness T2 of the thick part 423 which is represented by T1/T2 is preferably within a range of ½ to 9/10.

By setting the proportion T1/T2 within the above-mentioned range, the side surface electrode part 42 less projects out from the circumference surface 220 of the second flange 22 at the position corresponding to the recessed part 420, and a risk of the circumference surface of the coil 30 contacting the side surface electrode part 42 can be reduced; or a risk of the circumference surface of the coil 30 contacting the solder fillet formed to the side surface electrode part 42 can be reduced. Particularly, by making the thickness of the side surface electrode part 42 thinner towards the center part of the side surface electrode part 42 in X-axis direction, the thin part 422 having thin electrode thickness can be formed in a wide area along X-axis direction taking the center part of the side surface electrode part 42 as a center. Thereby, a risk of the circumference surface of the coil 30 contacting the side surface electrode part 42 can be effectively reduced, or a risk of the circumference surface of the coil 30 contacting the solder fillet formed to the side surface electrode part 42 can be effectively reduced.

The thick part 423 is formed to the outer side of the thin part 422 (the recessed part 420) in X-axis direction. The side surface electrode part 42 has two thick parts 423, and the thin part 422 is positioned between the two thick parts 423. The thickness of the thin part 422 is thinner than the thick part 423. The thick part 423 has a convex shape which projects out in Y-axis direction of the second flange 22. The surface of the thick part 423 has roughly a C-like shape (arc shape) when viewed from Z-axis direction.

The thickness of the thick part 423 becomes thinner towards the supplementary electrode 43 (or towards the intersection between the second surface 220b and the third surface 220c of the second flange 22). Also, the thickness of the thick part 423 becomes thinner towards the wire connecting part 41 (or towards the intersection between the second surface 220b and the first surface 220a of the second flange 22). Also, the thickness of the thick part 423 becomes thinner towards the thin part 422. That is, each of the thick parts 423 of the side surface electrode part 42 has a tapered shape which gradually becomes thinner towards X-axis positive direction and X-axis negative direction. Since the side surface electrode part 42 has the thick part 423, the damage to the corner between the first surface 220a and the second surface 220b of the second flange 22 can be effectively prevented, or the damage to the corner between the second surface 220b and the third surface 220c can be effectively prevented.

At the side surface electrode part 42 (particularly at the position of the recessed part 420), the thickness (the maximum thickness or the average thickness) of the first electrode 40 is preferably thinner than the wire connecting part 41. Note that, the thickness of the wire connecting part 41 is preferably 25 μm or more. In such case, the connection reliability of the lead part 30a of the coil 30 to the wire connecting part 41 can be enhanced.

As shown in FIG. 5B, the thickness of the side surface electrode part 42 becomes thinner towards the inner end surface 222 side of the second flange 22. As shown in FIG. 6A and FIG. 6B, at the outer end surface 221 side of the second surface 220b of the second flange 22 (see FIG. 6A), the thin part 422 and the thick part 423 are thinner compared to the inner end surface 222 side of the second surface 220b (FIG. 6B side). Note that, as shown in FIG. 6B, regarding the thin part 422, the thickness is substantially zero.

As such, the side surface electrode part 42 has a tapered part 424 where the thickness gradually becomes thinner towards the inner end surface 222 side (see FIG. 5B). At the position of the thin part 422 shown in FIG. 5A, the tapered part 424 is formed to an area between the electrode non-formed area 425 and the outer end surface 221 of the second flange 22. Also, at the thick part 423 shown in FIG. 5A, the tapered part 424 is formed from the outer end surface 221 of the second flange 22 to the area near the inner end surface 222. Note that, not only the side surface electrode part 42 but also the wire connecting part 41 and the supplementary electrode part 43 may also have the above-mentioned tapered shape.

The side surface electrode part 52 of the second electrode 50 has a recessed part (not shown in figure) as similar to the recessed part 420 formed to the side surface electrode part 42 of the first electrode 40. Also, as shown in FIG. 5A and FIG. 5B, the side surface electrode part 52 has a thin part 522, a thick part 523, a tapered part 524, and an electrode non-formed area 525. The shape of the side surface electrode part 52 of the second electrode 50 is the same as the side surface electrode part 42 of the first electrode 40, hence the detailed description will be omitted.

Next, a method of producing the coil device 10 is described. First, the core 20 of a drum shape shown in FIG. 2 is prepared. Next, the first electrode 40 and the second electrode 50 are formed to the circumference surface 220 and the outer end surface 221 of the second flange 22 of the core 20. For example, the first electrode 40 may be formed by applying an electrode material on the circumference surface 220 (the first surface 220a, the second surface 220b, and the third surface 220c) and the outer end surface 221 of the second flange 22. At this time, the electrode material is applied on the second surface 220b so that the shape of the recessed part 420 shown in FIG. 2 is formed. Alternatively, the first electrode 40 may be formed using a dip method. Although the detailed explanation is omitted, when the first electrode 40 is formed using a dip method, a desired procedure is carried out using a jig and so on so that the shape of the recessed part 420 shown in FIG. 2 is formed. The same applies to the second electrode 50.

Next, the coil 30 is wound around the core center part 23 (FIG. 5A), and the lead part 30a of the coil 30 is connected to the wire connecting part 41 of the first electrode 40, for example, using a heat compression. Also, the lead part 30b of the coil 30 is connected to the wire connecting part 51 of the second electrode 50, for example, by a heat compression. Next, as shown in FIG. 1, the exterior resin 60 is applied between the first flange 21 and the second flange 22 so that the circumference surface of the coil 30 is covered, and then the exterior resin 60 is cured. Note that, the exterior resin 60 may include metal powder and so on. By going through the above-mentioned steps, the coil device 10 can be produced.

As mentioned in above, in the coil device 10 according to the present embodiment, the side surface electrode 42 shown in FIG. 2 has the recessed part 420 which is recessed toward the outer end surface 221 side of the second flange 22. Therefore, at the position corresponding to the recessed part 420, the side surface electrode part 42 is spaced apart from the circumference surface of the coil 30 by the distance corresponding to the depth of the recessed part 420. Thereby, a risk of the circumference surface of the coil 30 and the side surface electrode part 42 contacting each other can be reduced, and also the short circuit between the coil 30 and the side surface electrode part 42 can be prevented.

Also, at the position corresponding to the recessed part 420, the side surface electrode part 42 is formed at the position spaced away from the inner end surface 222 of the second flange 22 along Z-axis direction by the distance which corresponds to the recesses of the recessed part 420. Therefore, when the solder fillet adheres to the side surface electrode part 42, part of the solder fillet becomes difficult to be on (overflow towards) the inner end surface 222. Thereby, a risk of the circumference surface of the coil 30 and the solder fillet contacting each other can be reduced, also the short circuit between the coil 30 and the solder fillet can be prevented.

Further, when the side surface electrode part 42 is formed to the circumference surface 220 of the second flange 22, the electrode material is applied to the circumference surface 220 in a way that the recessed part 420 is formed to the circumference surface 220, thereby prevents the electrode material from unwantedly being on the inner end surface 222.

Also, the side surface electrode part 42 extends in X-axis direction along the circumference direction of the second flange 22, and the recessed part 420 is formed at the center part in X-axis direction of the side surface electrode part 42. Thus, the recessed part 420 can be formed in a wide area along X-axis direction taking the center area of the side surface electrode part 42 as a center. Therefore, a risk of the circumference surface of the coil 30 contacting the side surface electrode part 42 can be effectively reduced, or a risk of the circumference surface of the coil 30 contacting the solder fillet adhered to the side surface electrode part 42 can be effectively reduced.

Also, usually, the side surface electrode part 42 and the circumference surface of the coil 30 are arranged closest to each other (see the position P of FIG. 2) particularly at the center part of the side surface electrode part 42 in X-axis direction. Therefore, by forming the recessed part 420 at the center part of the side surface electrode part 42 in X-axis direction, a risk of the circumference surface of the coil 30 contacting the side surface electrode part 42 can be effectively reduced, or a risk of the circumference surface of the coil 30 contacting the solder fillet adhered to the side surface electrode part 42 can be effectively reduced.

Also, as shown in FIG. 5B, the thickness of the side surface electrode part 42 becomes thinner towards the inner end surface 222 of the second flange 22. Therefore, the closer the position is to the coil 30, the projection to the outer side in Y-axis direction of the side surface electrode part 42 from the circumference surface 220 of the second flange 22 is suppressed, and a risk of the circumference surface of the coil 30 contacting the side surface electrode part 42 can be effectively reduced. Also, the closer the position is to the coil 30, the projection to the outer side in Y-axis direction of the solder fillet formed to the side surface electrode part 42 is suppressed, and a risk of a circumference surface of the coil 30 contacting the solder fillet can be effectively reduced. In addition, part of solder fillet formed on the side surface electrode part 42 becomes difficult to be on the inner end surface 222 of the second flange 22. From this point as well, a risk of the circumference surface of the coil 30 contacting the solder fillet can be effectively reduced.

Note that, the present disclosure is not limited to the above-mentioned embodiment and it can be modified variously within the scope of the present disclosure.

In the above-mentioned embodiment, an example of applying the present disclosure to an inductor has been explained, however, the present disclosure may be applied to a coil device other than an inductor (such as transformer and so on).

In the above-mentioned embodiment, as shown in FIG. 2, one recessed part 420 is provided to the side surface electrode part 42, however, a plurality of recessed parts 420 may be provided. The same applies to the second electrode 50.

In the above-mentioned embodiment, as shown in FIG. 2, the lead part 30a is connected to the wire connecting part 41 formed to the first surface 220a of the second flange 22, however, the lead part 30a may be connected to the side surface electrode part 42 formed to the second surface 220b. In such case, the wire connecting part 41 can be omitted. Note that, the lead part 30a may be formed to the position different from where the recessed part 420 is formed (for example, at the thick part 423 shown in FIG. 5A). The same applies to the lead part 30b.

In the above-mentioned embodiment, the supplementary electrode 43 may not be provided to the first electrode 40. Also, the supplementary electrode 53 may not be provided to the second electrode 50.

### NUMERICAL REFERENCES

10 . . . Coil device
20 . . . Core
21 . . . First flange
22 . . . Second flange
220 . . . Circumference surface
221 . . . Outer end surface
222 . . . Inner end surface
23 . . . Core center part
30 . . . Coil
30a,30b . . . Lead part
40 . . . First electrode
41 . . . Wire connecting part
42 . . . Side surface electrode part
420 . . . Recessed part
421 . . . Base surface
422 . . . Thin part
423 . . . Thick part
424 . . . Tapered part
425 . . . Electrode non-formed area
43 . . . Supplementary electrode part
44 . . . Mounting part
50 . . . Second electrode
51 . . . Wire connecting part
52 . . . Side surface electrode part
522 . . . Thin part
523 . . . Thick part
524 . . . Tapered part
525 . . . Electrode non-formed area
53 . . . Supplementary electrode part
54 . . . Mounting part
60 . . . Exterior resin

What is claimed is:

1. A coil device comprising
a core having a core center part for disposing roughly perpendicularly to a mounting surface and a flange formed to one end in an axial direction of the core center part;
a coil disposed around the core center part; and
an electrode connected to a lead part of the coil;
wherein
the electrode on a circumference surface of the flange has a recessed part which is recessed from an edge of the electrode towards an outer end surface of the flange.

2. The coil device according to claim 1, wherein the circumference surface of the flange comprises an electrode non-formed area corresponding to the recessed part, wherein
the flange has an intersection located between an inner end surface and the circumference surface;
the electrode non-formed area is provided between the electrode and the intersection; and
the electrode non-formed area does not have the electrode.

3. The coil device according to claim 1, wherein the electrode extends along a circumference direction of the flange, and
the recessed part is formed at a center area in an extending direction of the electrode.

4. The coil device according to claim 1, wherein the electrode extends along a circumference direction of the flange, and
a thickness of the electrode on the circumference surface becomes thinner toward a center area in an extending direction of the electrode.

5. The coil device according to claim 2, wherein the electrode extends along a circumference direction of the flange, and
a thickness of the electrode on the circumference surface becomes thinner toward a center area in an extending direction of the electrode.

6. The coil device according to claim 1, wherein a thickness of the electrode on the circumference surface becomes thinner toward an inner end surface of the flange.

7. The coil device according to claim 4, wherein a thickness of the electrode on the circumference surface becomes thinner toward an inner end surface of the flange.

8. The coil device according to claim 1, wherein the electrode includes a wire connecting part connected to a lead part of the coil, and
the wire connecting part is provided at a different position from a position of the recessed part.

9. The coil device according to claim 8, wherein the flange has a polygonal shape when viewed from the axial direction of the core center part,
the circumference surface of the flange has a plurality of surfaces along a circumference direction of the flange,
the electrode is formed in a continuous manner to at least two surfaces among the plurality of surfaces of the circumference surface of the flange, and
the wire connecting part is formed on one of the surfaces different from another one of the surfaces that the recessed part is formed.

10. The coil device according to claim 8, wherein the electrode on the circumference surface has a thinner thickness at the position of the recessed part compared to the position of the wire connecting part.

11. The coil device according to claim 1, wherein the electrode comprises a metal and glass.
